(19) United States
(12) Patent Application Publication
(10) Pub. No.: US 2002/0095585 A1
(43) Pub. Date: Jul. 18, 2002

(54) Genomic profile information systems and methods

(75) Inventor: Randal Scott, Los Altos Hills, CA (US)

Correspondence Address: KLARQUIST SPARKMAN, LLP, One World Trade Center, Suite 1600, 121 S.W. Salmon Street, Portland, OR, 97204, US

(73) Assignee: Genomic Health, Inc.

(21) Appl. No.: 10/035,814

(22) Filed: Oct. 18, 2001

Related U.S. Application Data
(60) Provisional application No. 60/241,495, filed on Oct. 18, 2000.

(51) Int. Cl. H04L 9/00

(52) U.S. Cl. 713/185

(57) ABSTRACT

A variety of methods and systems related to genomic profile information and related participants are described. Participants can be encouraged to allow access to their genomic profile information in a variety of ways. A peer-to-peer genomic profile information network can be implemented. A collection of genomic profile information for a large number of participants can be built, and anonymity of the participants can be maintained. Participants can maintain custodial control over their genomic profile information. Comparative tools and groups can help participants identify and communicate with other participants having similar information.

### RELATED APPLICATIONS

This application claims the benefit of U.S. Provisional Application No. 60/241,495, filed Oct. 18, 2001, and entitled “GENOMIC PROFILE INFORMATION CENTER,” which is hereby incorporated herein by reference.

### TECHNICAL FIELD

The technical field relates to a variety of methods and systems directed to acquiring, storing, and providing access to genomic profile information, including, for example, an Internet-accessible personal genomic profile information collection system having entries for many participants.

### BACKGROUND

The complete blueprint for a living organism resides in the organism's genome. Although the totality of information in the genome is not fully understood, it is known that the information in the genome includes genes for generating the vast number of proteins that regulate and perform biological functions for the organism.

Scientists have devoted considerable time and resources to mapping genomes for various organisms, including the human genome. As the field progresses, researchers are beginning to understand the structure, expression, and function of genes in the genome. As a result of these and other efforts, a variety of technologies have been improved and refined to both increase effectiveness and reduce the cost of collecting genomic information. For example, advances in DNA microarray and polymerase chain reaction (PCR) technologies now allow researchers to measure gene expression for thousands of genes at once. However, there still remains a need for better methods and systems for collecting genomic information, providing access to the information, making use of the information collected, and correlating the information with other participant-related information, such as medical information.

### SUMMARY OF THE DISCLOSURE

Although recent developments in genomic science have significantly advanced the technologies for collecting and analyzing genomic information, the field is hindered by several problems.

One of the impediments to better understanding genomic information is the lack of easy access to genomic information for a large number of biological subjects. For example, in the case of the human genome, many persons are hesitant to provide personal genomic information because of privacy concerns. Further, even if privacy concerns are addressed, persons are unlikely to volunteer their information because collecting and providing the information takes some time and effort. In addition, unidirectional database systems might involve genomic profile information originating from patients who do not ever receive access to their own information, let alone information indicating how their genomic profile information compares to that of other patients. Finally, the benefits related to collecting the information might not be realized for many years after the information is collected and might not ever be enjoyed by the person providing the information.

In some embodiments disclosed herein, individual participants are motivated to provide their personal genomic information, including information from provided biological samples, by providing the participants with ownership of their information, control of their information, compensation in exchange for sharing or licensing the information to third parties, or some combination thereof.

Participants can be compensated in a variety of ways. Participants can be compensated by providing services. For example, a participant can be provided a subscription service, including some level of access to genomic profile information of other participants, including searching access. Other services, such as genomic profiling services and clinical trials for experimental therapy can be provided. A participant's personal genomic profile can be pooled with profiles of others to form a collection of genomic information. Information from the collection can then be sold to a research entity. Participants having contributed their information to the pool can then be compensated via the payment from the research entity.

As the participants may be patients, a patient-owned genomic profile information system creates a large incentive for individuals to participate and thus can have a significant commercial advantage over systems not providing an incentive to participants. Software systems as described can be implemented to handle large participant loads attracted by the incentives (e.g., the system can contain information for over 10,000, over 100,000, over 1,000,000, over 10,000,000, or over 100,000,000 participants). Patient-driven storing, retrieving, searching, and comparing genomic profile information can be supported.

The genomic profile information can be provided via a genomic profile information network having a variety of architectures. In some embodiments, a central database holds information accessed by client computers. Alternatively, the information can be distributed among many computers. For example, information relating to a participant can be stored via a computer controlled by the participant, and the participant can control access to the information on the computer via a network connection. Access to the information can be accomplished, for example, via a client-server network arrangement, a peer-to-peer network arrangement, or a client-server/peer-to-peer combination. The participant can choose to provide direct access to the participant's information, release it to a central store for access by others, or release it for inclusion in a collection of other individuals for another purpose.

Even though the participants can remain anonymous, the value of the information to researchers in some cases is so high that significant compensation can be provided to the participants. Such an incentive leads others to participate, further building the value of the genomic profile information collection. For example, as the number of participants builds, a significant number of individuals meeting various criteria contribute to the database. Thus, researchers wishing to acquire a collection of personal genomic information for participants meeting specific criteria can turn to the genomic profile information collection as a valuable resource.

The greater value of the collection can lead to still greater compensation, so the compensation arrangement results in an unprecedented collection of personal genomic profile information, from which both the scientific community at large and individual participants can benefit. Besides those affected with disease and illness, those in good health may wish to consult the data to identify or avoid potential diseases and illnesses.

In one implementation, a person is directed to supply a biological sample from her body to a laboratory. When the genomic profile information center receives an analysis of the biological sample from the laboratory, it incorporates the analysis into a personal genomic profile for the person. The personal genomic profile is pooled with personal genomic profiles from other people into a collection of anonymous personal genomic profiles. The collection of anonymous pooled personal genomic profiles can be sold to a requesting entity for payment, and, as a result of the sale, the person is compensated via the payment.

In certain embodiments, other incentives or compensation are provided to participants who add their personal genomic information to the database. For example, participants are provided with tools for comparing their personal genomic information with others in the database. A participant wishing to view data for other participants having similar genomic information may query the database. Even though the participants can remain anonymous, valuable information such as effective courses of disease treatment can be gathered by the participants.

Because the participants are often motivated to analyze the data by illness or disease, direct access to the information by the participant can lead to more concentrated study of particular genomic phenomena. Such an approach can shorten the time between a scientific discovery in the field of genomics and practical impact of the discovery.

In addition, certain disclosed embodiments involve collective action on the part of participants. For example, a participant can join a group of other participants having similar characteristics, such as a similar gene, illness, or disease. The group can pool and share information. Members of the group are typically highly motivated by personal self-interest. For example, members of a group may have a chronic or life-threatening condition. Because the group is highly motivated, direct access to genomic information by the group can lead to significant advances in the understanding of genomic information.

A participant can serve as custodian of the participant's own personal genomic profile. In such an arrangement, the participant is sometimes said to “own” her personal genomic profile. The participant can specify a wide variety of custodial directives related to the profile, including controlling levels of access to the data and whether to provide the profile (e.g., for sale) to be used for research studies. In a peer-to-peer arrangement, a participant can provide access to her personal genomic profile via a computer system under her control.

Information about therapies can be included so that participants can investigate (e.g., via software comparison tools) the outcome (e.g., drug response) of a particular therapy for someone having a similar disease and molecular portrait (e.g., based on gene expression). Useful information can thus be obtained, even though anonymity of the participants can be preserved.

In disclosed embodiments, information is exchanged via a computer communications network, such as the Internet. Implementing various aspects via the Internet provides various advantages, including easy access and privacy. Internet access to the database allows a variety of participants and researchers to access the data at any time from any location. Participants who are away from their home due to illness or disease can provide and access information anonymously.

The foregoing and other features and advantages will become more apparent from the following detailed description of disclosed embodiments which proceeds with reference to the accompanying drawings.

### BRIEF DESCRIPTION OF THE FIGURES

FIG. 1 is a block diagram of a system suitable for implementing a genomic profile information center.

FIG. 2 is a flowchart showing a method for building a genomic profile information database via compensation provided to a participant.

FIG. 3 is a flowchart showing a method for building a genomic profile information database via the Internet.

FIG. 4 is a flowchart showing a method for building a genomic profile information database by providing participants with analysis tools.

FIG. 5 is a flowchart showing a method for building a genomic profile information database by granting access to group information and functions.

FIG. 6 is a flowchart showing a method for building a genomic profile information database by granting custodial control of a participant's personal genomic profile information to the participant.

FIG. 7 is a flowchart showing a method for collecting personal genomic profile information.

FIG. 8 is a screenshot of a screen presented to a user for registering as a center participant.

FIG. 9 is a screenshot of a user choosing a service level.

FIG. 10 is a screenshot of a user forming a contract with the center over the Internet.

FIG. 11 is a screenshot of options presented to a participant for performing functions on her genomic profile information.

FIG. 12 is a screenshot of an electronic form presented to a participant for adding medical information.

FIG. 13 is a screenshot of options presented to a participant for controlling access to personal genomic profile information.

FIG. 14 is a screenshot of a personal genomic home page.

FIG. 15 is a screenshot of a message sent to a center participant from a researcher inviting the participant to register with a research study.

FIG. 16 is a screenshot of options presented to a participant for gene expression information research.

FIG. 17 is a screenshot of a function for initiating a comparative gene expression analysis.

FIG. 18 is a screenshot of a graphical depiction of a cluster of participants having gene expression information similar to a comparing participant.

FIG. 19 is a screenshot of a comparison between gene expression information for a comparing participant and an anonymous participant selected from the cluster of FIG. 18.

FIG. 20 is a block diagram showing an exemplary implementation of a genomic profile information collection.

### DETAILED DESCRIPTION OF EXEMPLARY EMBODIMENTS

The described technologies include methods and systems related to genomic profile information.

### Exemplary System

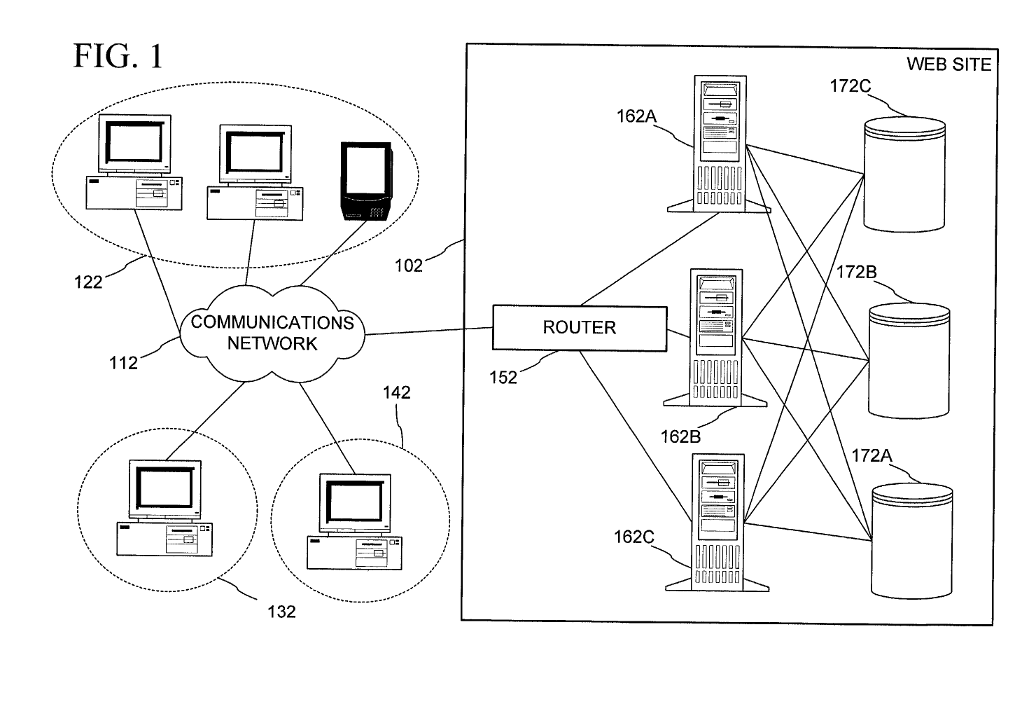

FIG. 1 illustrates an exemplary system 102 for implementing a genomic profile center. In the example, the center is implemented as a web site 102, which includes a set of computers arranged into what is commonly called a “web farm.” The system can be accessed by computers connected to the communications network 112 (e.g., the Internet). In the example, the system is accessed by participant computers 122, researcher computers 132, and laboratory computers 142, all of which have access to the communications network 112. The system may also be accessed by center administrators. The various computers can thus form parts of a genomic profile information network or genomic profile information collection system.

Access to the system is achieved via a router 152, which itself may be a computer or other configurable device that routes requests for data (e.g., web pages) to an appropriate web server 162A, 162B, or 162C. While processing requests for information, the web servers 162 may call upon databases 172A, 172B, and 172C, which can be implemented as database servers. Although there are only three web servers and three databases shown, there may be many more in some implementations. Typically, redundancy and load balancing is built into the system to handle a large number of simultaneous sessions by a plurality of users.

Access to the databases 172 is selectively controlled to preserve the anonymity of the profile participants. For example, a participant may be identified by an identifier other than a name. Knowledge of the identifier's relationship to a particular participant can be limited to only the participant and secure designees. For example, a link between the identifier and a participant need not be stored in the database or any electronic medium. Other participants can then use the participant's identifier to refer to the participant and request information via software or communicate with the participant over a communications network, if so allowed by the participant. Various secure systems such as voice authentication or other secure biometric system can be used to identify a participant, restrict access, or authenticate the identity of a participant. Thus, a participant's identify can be authenticated over a communications network via biometric screening.

Typically, read rights are defined so that a record in the databases can be made inaccessible to a requestor not having adequate authorization or authentication. As defined in further detail below, software is provided by which participants can compare the personal genomic profile with other participants to generate a graphical display of the comparison.

Data relating to a participant can be stored and maintained in the central databases 172A, 172B, and 172C. Alternatively, data for a participant can be stored and maintained at a data store local to a computer system under the participant's control (e.g., one of the participant computers 122). In such an arrangement, the database can take the form of a distributed database. Information relating to participants can thus be spread over plural computer systems, and more sensitive information can be partitioned from less sensitive information. Thus, if desired, a participant can maintain more controlled custodial control of information considered sensitive by the participant.

Access to a participant's information can be provided by pooling it with information from other participants in a central database, or access can be accomplished directly to a computer under the participant's control. Thus, a peer-to-peer genomic information network (e.g., a patient-to-patient genomic information network) can be implemented to provide access by others to a collection of genomic profile information (e.g., including medical and personal information) for a number of participants.

In a peer-to-peer arrangement, access to a central database may still be desired. For example, a participant wishing to perform a search may search a central database to identify the existence of other participants meeting specified criteria. If another participant has released information relating to the criteria to the central database, the searching participant can then be directed to access further information about the other participant directly from a computer under the other participant's control, if the other user has authorized such access.

Although a wide variety of hardware and software configurations are possible, one configuration involves a set of INTEL PENTIUM computers running MICROSOFT INTERNET INFORMATION SERVER to access MICROSOFT SQL databases. For some fields having potentially sizable entries in the database, it is sometimes preferable to store the entries as separate files; the database refers to such data by indicating the name of the appropriate file.

The computers depicted often include a hard disk drive, a magnetic disk drive (e.g., to read from or write to a removable disk), and an optical disk drive (e.g., for reading a CD-ROM disk or to read from or write to other optical media). The drives and their associated computer-readable media provide nonvolatile storage of data, data structures, computer-executable instructions and the like for the computer. Although the description of computer-readable media above refers to a hard disk, a removable magnetic disk, and a CD, other types of media which are readable by a computer, such as ROM, magnetic cassettes, flash memory cards, digital video disks, and the like, may be used.

### Exemplary Methods for Building the Genomic Profile Database

Problems related to motivating individual participants to contribute to the database include privacy concerns, lack of control over the data, and failure to develop a workable system to compensate participants for their contributions. Exemplary embodiments can avoid these problems.

Providing Compensation to the Participants

A single personal genomic profile typically has limited value to researchers. However, a large collection of personal genomic profiles, or a specialized collection of personal genomic profiles can have great value. Illustrated embodiments can create value by collecting numerous personal genomic profiles and then offering the profiles for sale to third parties, such as research entities. Proceeds from the sale can be passed back to those who provided the personal genomic profiles.

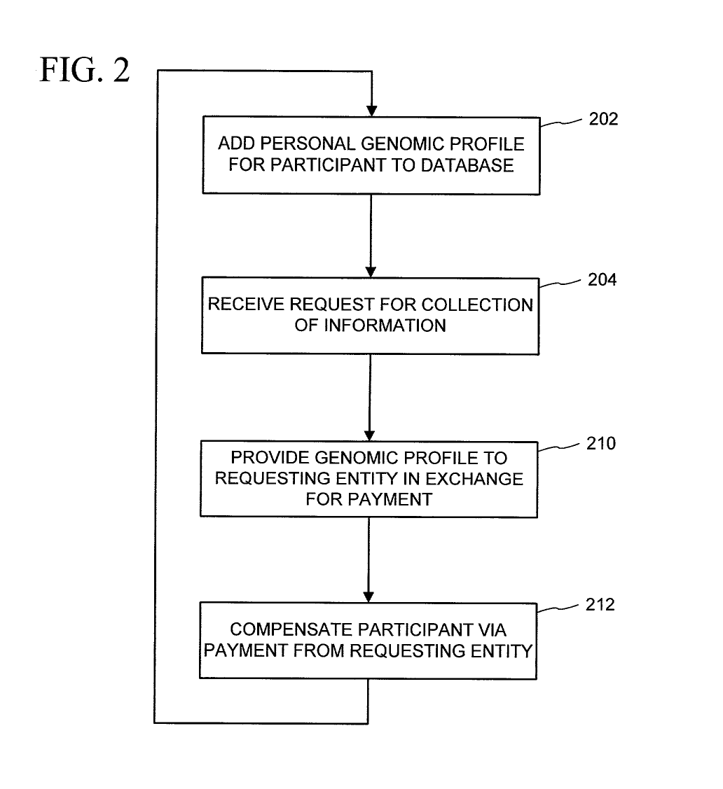

An example of such a method is illustrated in FIG. 2. At 202, the personal genomic profile for a participant is added to a database. At 204, a request is received for a collection of information from the database. For example, a research entity might request all genomic profiles or genomic profiles for participants in the database meeting specified criteria. Responsive to the request, at 210, the collection of information, including the personal genomic profile of 202, is provided to the requesting entity in exchange for payment.

Payment can take the form of cash, but a variety of other compensation can be provided. For example, compensation can be provided in the form of credits for goods or services (e.g., genomic profiling services, subscription services for accessing genomic profile information, searching and analysis tools, or access to additional information) or entry into a clinical trial. Such clinical trials can be designed to test new therapies related to an individual's disease condition.

At 212, the participant is compensated, based on having provided the collection of information to the requesting entity. The method can be repeated many times, and the number of personal genomic profiles can greatly exceed the number of requesting entities. In other words, 202 and 204 may be performed more often (e.g., for different participants) than 210 and 212. One of the benefits of the arrangement is that it results in a large number of participants, who are motivated to supply genomic profile information by the potential to receive compensation for having provided their information.

The illustrated method can be varied and still prove effective. For example, compensation to a participant need not be strictly tied to having provided the participant's profile to a paying requestor. Instead, a percentage of payment can be provided to the participant for having contributed to the database, whether or not her particular profile was provided in exchange for the payment. Or, a combination of compensation arrangements can be used, where a participant is compensated pro-rata from the payment, and the percentage is increased based on the participant's profile having been included in the collection of information provided to the paying requester.

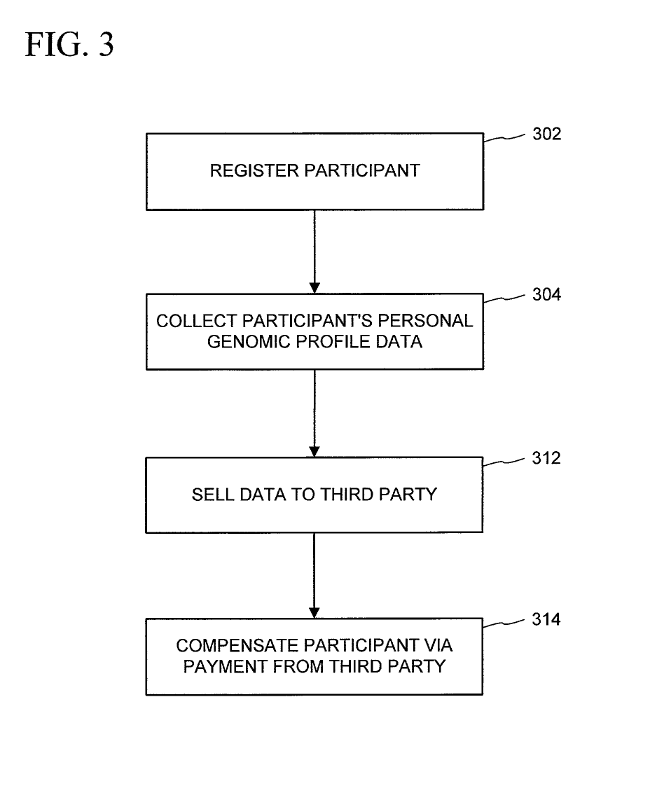

An example of a method as implemented on the Internet is shown in FIG. 3. At 302, the participant registers herself in the database via an online form, such as that presented in an Internet browser. Subsequently, the participant's personal genomic profile data is collected at 304. The participant's data can come directly from the participant as well as from other sources, such as a lab analyzing a biological sample provided by the participant from the participant's body. At 306, the participant's data is sold to a third party. At 314, the participant is compensated via the payment from the third party.

Providing Analysis Tools to the Participant

In addition to providing compensation as described above, participants can be motivated to contribute their personal genomic profile information by providing them with tools to analyze their personal genomic profile information. For example, a participant can perform a comparative analysis that analyzes their own data in light of others and identifies other individuals with similar genomic or molecular characteristics.

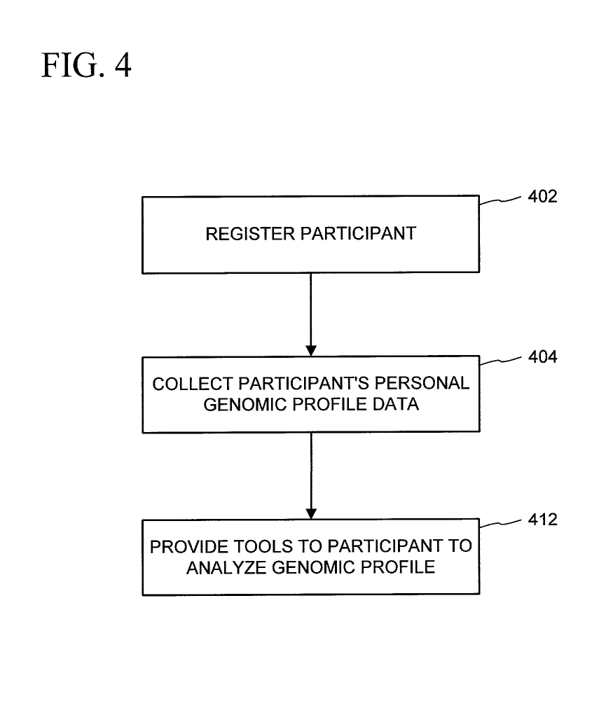

An example of such a method as implemented on the Internet is shown in FIG. 4. At 402, the participant registers with the center. At 404, the participant's personal genomic profile data is collected. At 414, tools are provided to the participant to analyze her genomic profile. The tools provided in exchange for collecting the data can vary based on the level of access the participant provides to her genomic profile. For example, at one level, participants might be granted access to research and articles relating to their profile. At another level, in exchange for making an anonymous version of her personal genomic profile available to others via the center, the participant can be provided with comparative analysis tools to compare her personal genomic profile with those of other participants. Such comparative analysis tools can include identifying a cluster of other participants having characteristics similar to those of the participant.

After the participant identifies other participants having similar characteristics, the participant may wish to exchange information with those persons. The center provides a variety of communication modes, some of which maintain anonymity. In this way, the participant is motivated to make her personal genomic profile available to others.

Providing Access to Group Information and Functions

Still another way to motivate participants to contribute their information is by providing group information and functions. Groups can be created to focus on particular characteristics or conditions related to genomic or molecular profiles. For example, a group can be designated for members interested in avoiding or treating illness and diseases, such as breast cancer, diabetes, cardiovascular disease, atherosclerosis, inflammation, blood borne cancers, other cancer, obesity, basic health and longevity, asthma, and severe skin disorders. Groups can also be based on age, sex, race, and the like. Participants can join the group to share information and ideas. Since members of the group are typically highly motivated by personal self-interest, the collective action of the group can lead to significant advances in the understanding of genomic science that benefit both the scientific community at large and individual participants in the group.

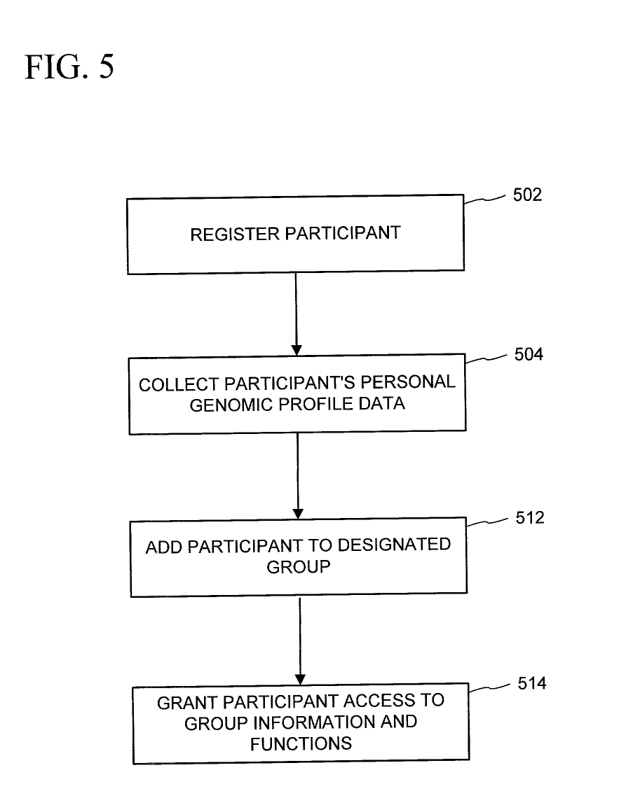

An example of a method related to groups is shown in FIG. 5. At 502, a participant registers. At 504, the participant's personal genomic profile data is collected. At 512, the participant is added to the group. The participant may initiate a request to be added, or the center may present the participant with a list of appropriate groups, based on a review of the participant's personal genomic profile. At 514, the participant is granted access to group information and functions. Levels of access to the group information and functions can be made to depend on the level of access the participant provides to her personal genomic profile.

For example, all participants may have access to the number (e.g., “132”) of participants in a group. In exchange for identifying oneself as an anonymous member of the group, the participant may be provided with research and articles pertaining to the group. Further, in exchange for making one's personal genomic profile anonymously available to others in the group, access to anonymous versions of other group members' personal genomic profiles can be granted.

In addition, a group moderator can be designated to provide content to the group. For example, messages about breaking news or other information can be targeted to members of particular groups, and information can be organized for presentation as appropriate to members of the group.

Preserving the Participant's Ownership of the Data

Under conventional approaches, a person who provides access to her personal genetic information for genetic research loses control over the data. Consequently, persons are not sufficiently motivated to provide a biological sample or other information.

By contrast, in illustrated embodiments, participants can maintain control over their personal genomic profiles and can perform various custodial functions with respect to the profiles. For example, a participant can control the level of access by other participants, other group members, and third party research entities. The participant can decide when and how to perform comparative genomic analyses, when to join groups, when to sell the data, and to whom the data will be sold. In such an arrangement, the participant is sometimes said to maintain “ownership” of the profile. Such ownership functions can be performed over a communications network via a computer user interface.

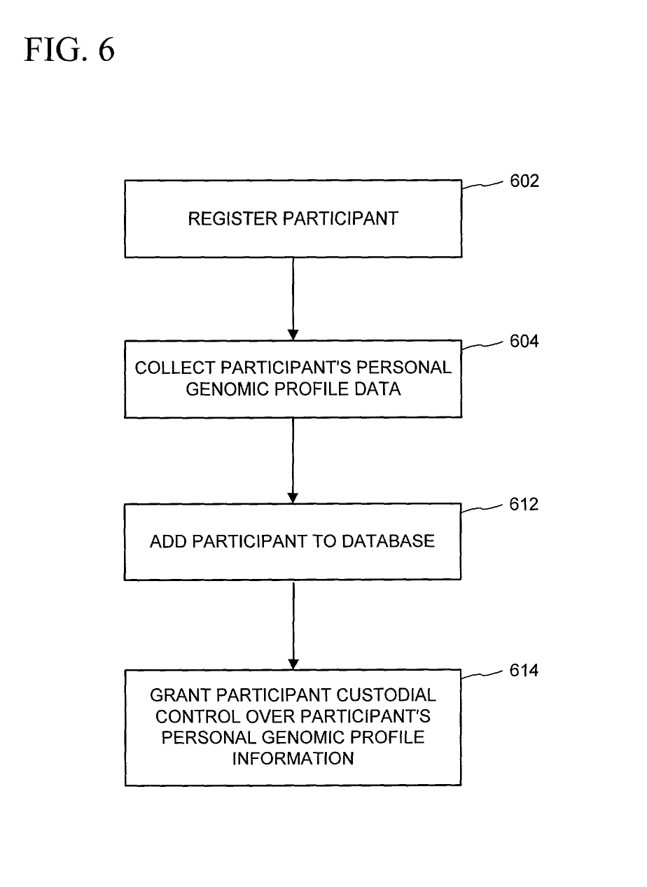

A method involving such an arrangement is illustrated in FIG. 6. At 602, the participant is registered. At 604, the participant's personal genomic profile data is collected. At 612, the participant is added to the database. However, access to the participant's personal genomic profile information is not made available to others. At 614, the participant is granted custodial control over her own personal genomic profile information. For example, the participant may make the information available to others anonymously or accept payment in exchange for providing the information to third parties.

Similarly, the participant can maintain ownership over any biological samples that are provided during information collection. The participant can thus order additional analysis to be performed on such samples and sell the results to third parties; the participant is compensated via the sale. In some cases, the center may charge a fee for sample storage.

To protect the anonymity of a participant, the participant can provide identification in the form of an anonymous identifier (e.g., a code or something other than the participant's name). Thus, the stored information need not be linked to the participant's name in various databases.

Other forms of custodial control can be achieved by storing a participant's genomic profile information on a computer system under the participant's control. For example, in a peer-to-peer arrangement, the participant's genomic profile information need not be pooled into a common database. Instead, access can be achieved by accessing the computer system under the participant's control via a communications network. In such an arrangement, certain information (e.g., the participant's identifier, group membership, and disease condition) might still be pooled into a common database to facilitate searching.

### Collecting Personal Genomic Profile Information

In illustrated embodiments, personal genomic profile information can take many forms. For example, genotype information, gene expression information, proteomics information, phenotype information, and medical information of a participant can be included in a genomic profile of the participant.

Genomic information can include, for example, gene expression profiling; DNA sequence, structure, expression, or function information; RNA sequence, structure, expression, or function information; protein sequence, structure, expression, or function information; genotypic and phenotypic variation information; pharmacogenomic information; pharmacogenetic information; genomic pathology information; molecular pathology; molecular profiling; pathway information; and any related biochemical information or molecular information of a participant.

Such genomic information can include, for example, DNA or RNA array data or analysis, PCR data or analysis, molecular diagnostic data or analysis, RT-PCR data or analysis, such as via TAQMAN® or other systems, microbead based data or analysis, SNP data or analysis, or other bioassay data or analysis. Such genomic information can be based on analysis of tissue, tissue biopsy, tissue resection, body fluids, blood, urine, sputum, cerebrospinal fluid, fixed tissue samples (e.g., paraffin-embedded fixed tissues), fine needle aspirates (FNAs), or other biological specimens.

Medical information can include, for example, any medical reports or analyses relating to the health or welfare status of a participant or participants or their response to various therapies, clinical outcomes, or other such medical information. Medical information can include, for example, pathology, diagnosis, molecular diagnostics, and outcomes information. Such information can include other personal information (e.g., sex, age, race, and the like) useful for inclusion in a genomic profile information network.

The genomic profile information can include, for example, genomic pathology information relating genomic data to a specific biopsy or tissue specimen from a participant, including fixed tissues, such as those fixed in formalin or other fixative and embedded in paraffin. The genomic profile information can further include therapeutic information regarding a link between participant and therapeutic outcome in response to a particular therapy or with respect to patient interaction with a particular therapy, such as metabolic, pharmacokinetic, adsorption, desorption, excretion, toxicity, or side effects to drugs or other response to therapy.

In some cases, information can be collected directly from participants. For example, in the case of medical information, information such as disease, illness, and family history can be collected over the Internet via forms presented in an Internet browser.

In other cases, the services of a professional laboratory can be employed to collect a biological specimen from a participant. Analysis of the biological specimen yields information, which can also be collected over the Internet via electronic forms or other techniques, such as email.

For example, the center can direct a participant to travel to a blood donation center and then ship the blood (e.g., via an express courier service) to a laboratory that will perform appropriate analysis. Results of the analysis can be provided directly to the participant, sent to the center, or both. The information from the analysis is then incorporated into the participant's personal genomic profile.

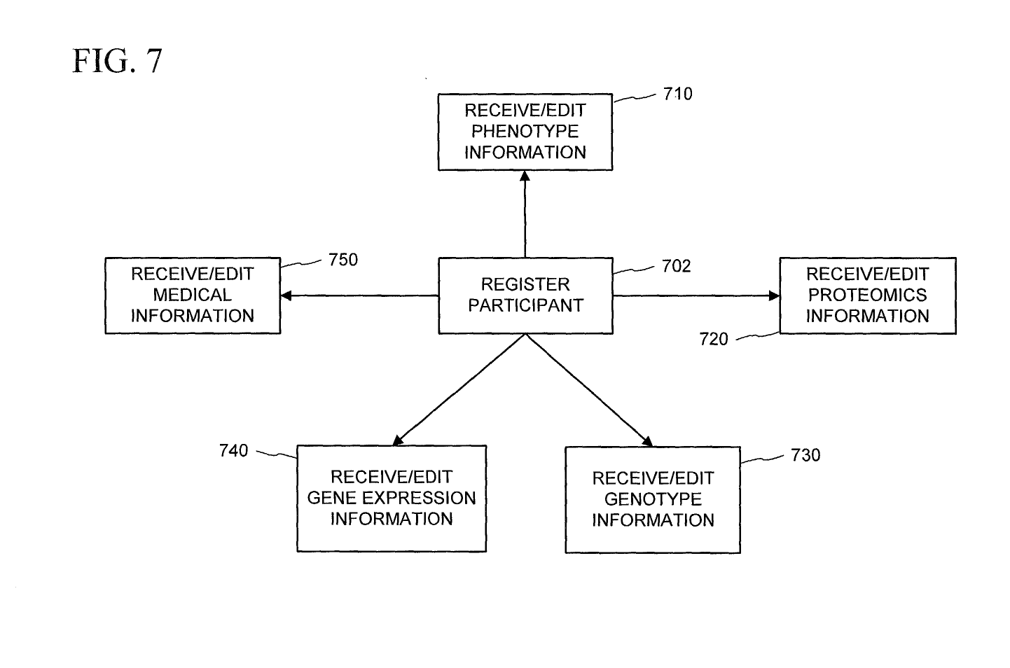

FIG. 7 shows a method for collecting personal genomic profile information. At 702, a participant is registered. For example, a user can register as a participant at a web site and be provided a user name and password or a biometric verification system (e.g., voice authentication). The participant can then be provided with instructions on how to provide gene profile information. Participants may provide various combinations of the information (e.g., some genotype information and some medical information, but no proteomics information). The information is combined to form a personal genomic profile, which can be updated over time. A preliminary registration process is provided by which a user can register and indicate contact information and disease interests without providing additional information.

At 710, phenotype information is received or edited. For example, a participant may enter her eye color via an HTML form.

At 720, proteomics information is received or edited. Such information can come from a laboratory that has performed analysis on a biological specimen of the participant.

At 730, genotype information is received or edited. Such information can come from a laboratory that has performed analysis on a biological specimen of the participant. For example, a basic plan can be provided to participants whereby they receive processing for ten genotypes per year in exchange for a subscription fee.

At 740, gene expression information is received or edited. Such information typically comes from a laboratory that has performed analysis on a biological specimen of the participant. For example, a participant can travel to a blood donation center and ship a blood sample via express courier to a laboratory. In one embodiment, a 200 gene expression profile from a blood sample (e.g., buffy coat) is designed to monitor key genes involved in disorders that can be detected in the blood stream. Single nucleotide polymorphism (SNP) data can be added over time. In another embodiment, gene expression information is gathered by analyzing fixed tissue samples (e.g., paraffin-embedded fixed tissues), such as a tumor.

At 750, medical information is received or edited. Such information may come directly from the participant, from a medical professional, or from some other source. For example, a participant may enter information about personal disease history, family disease history, and other medical treatment and diagnosis.

The technologies for acquiring the information described are expected to be refined and improved over time. Currently, for example, information for gene expression can be acquired via cDNA microarray technology and other techniques as described in M. Schena, D. Shalon, R. W. Davis, and P. O. Brown, “Quantitative monitoring of gene expression patterns with a complementary DNA microarray,” Science, 270 [5235], 467-70, 1995; Lockhart et al., U.S. Pat. No. 6,040,138, entitled “Expression Monitoring by Hybridization to High Density Oligonucleotide Arrays,” filed Sep. 15, 1995; PCT publications WO 99/44063 and WO 99/44062; U.S. Pat. No. 5,994,076 to Chenchik et al., entitled “Methods of assaying differential expression,” filed May 21, 1997; U.S. Pat. No. 6,059,561 to Becker, entitled “Compositions and methods for detecting and quantifying biological samples,” filed Jun. 9, 1998; Tewary et al., “Qualitative and quantitative measurements of oligonucleotides in gene therapy: Part I. In vitro models,” J Pharm Biomed Anal, 15:857-73, April 1997; Tewary et al., “Qualitative and quantitative measurements of oligonucleotides in gene therapy: Part II in vivo models,” J Pharm Biomed Anal, 15:1127-35, May 1997; Komminoth et al., “In situ polymerase chain reaction: general methodology and recent advances,” Verh Dtsch Ges Pathol, 78:146-52, 1994; and Bell et al., “The polymerase chain reaction,” Immunol Today, 10:351-5, October 1989, all of which are hereby incorporated herein by reference.

There are a wide variety of technological tools for analyzing gene expression profiles, including those described in Scherf et al., “A gene expression database for the molecular pharmacology of cancer,” Nature Genetics, v. 24, pp. 236-244 (March 2000), which is hereby incorporated herein by reference. The principles of these techniques can also be applied to other genomic profile data, such as proteomics.

In some cases, analysis of a biological sample involves analyzing a tumor (e.g., a cancer tumor). The database thus accommodates multiple analyses performed on multiple biological samples for the same participant.

### Custodial Functions Available to Participant

A participant can perform custodial functions on their personal genomic profile information over the communications network. For example, a user can control access levels to the information from a web page. Access levels can vary from no one other than the participant being able to see any data, some data being available to some people, or all data is available to everyone. Further, access control can be performed with respect to a group, and anonymity can be controlled by the patient.

### Participant-Driven Comparative Genomic Analysis

A participant can log in and perform comparative genomic analysis. The participant logs in, and compares her personal genomic profile with others to identify a cluster of participants having personal genomic profiles similar to hers.

On a general level, the software finds persons having common traits in the database, and displays a graphical representation of the persons having common traits. The identities of the persons can remain anonymous. Comparison can be a simple comparison to see which persons have the same traits.

In another comparative technique, various traits are assigned values. Each of the traits is considered a dimension. Traits can include genotype information, gene expression information, proteomics information, phenotype information, and medical information.

Each profile can then be defined as a point in Euclidean multi-dimensional space. Profiles having less distance from each other are considered to be “closer” for purposes of the analysis. A user can search for the n closest profiles to her own.

The center can identify a cluster of participants closest to a participant and display a graphical representation of the cluster, while still preserving the anonymity of the participants.

Another tool allows comparison of an arbitrary set of personal genomic profiles. Differences and similarities among profiles in the set can be displayed to a participant for analysis. For example, a participant can compare her genomic profile to others in a group and see how far from group averages her values lie. For example, a side by side comparison of a participant's genomic profile information with group averages can be presented, and likely aberrations highlighted.

Such comparisons can be done on any of the genomic profile information listed above.

During patient analyses, the participant can authorize the center's software to review the profile and suggest groups the participant may wish to join.

### Researcher-Driven Comparative Genomic Analysis

Researchers can also perform analyses on genomic information, once access to a personal genomic profile has been made available by a participant. Researchers can perform such analyses or access personal genomic profiles or pooled profiles via a computer user interface over a communications network.

### Groups

The center maintains a list indicating to which groups participants belong. Various group-related information and functions are available to group members. The center may designate some groups as available only to certain participants meeting certain verified criteria. Researchers may find such information helpful when requesting purchase of a collection of profiles.

### Internet Implementation

Implementing the genomic profile information center as a web site broadens the reach of the center. More people can participate; therefore, the collection of profiles becomes more valuable. As a result, higher amounts of compensation can be paid to participants, which motivates others to participate. The value of the collection thus builds even more, and so forth. An Internet implementation can operate by creating a session for a participant when she logs in. The center can then identify the participant via the session. Various security measures can be put into place to protect anonymity of the participants.

Databases store a variety of information. For example, when a sale of information is completed, compensation information can be stored in the database to indicate that a participant is to be compensated for having provided her genomic profile information.

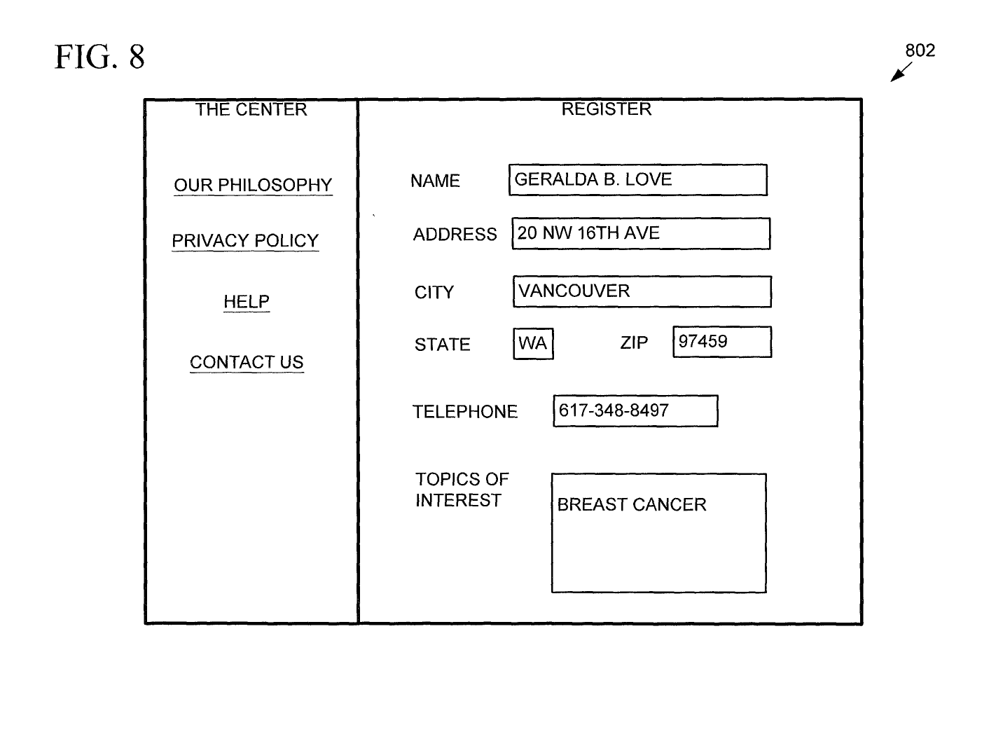

The screen shots shown in FIGS. 8-19 illustrate how various functions can be performed by a participant over a communications network, such as the Internet.

### Operation: First Example

An example of a registration form by which a user can register as a participant at the genomic information center is shown in the screenshot 802 of FIG. 8. The user navigates to the form via a URL, which may be accessed from any computer having Internet access. The information shown in this and other screenshots are presented as examples only. Other registration information (e.g., an email address) may be requested. In addition, there may be additional steps taken to verify the user's identity.

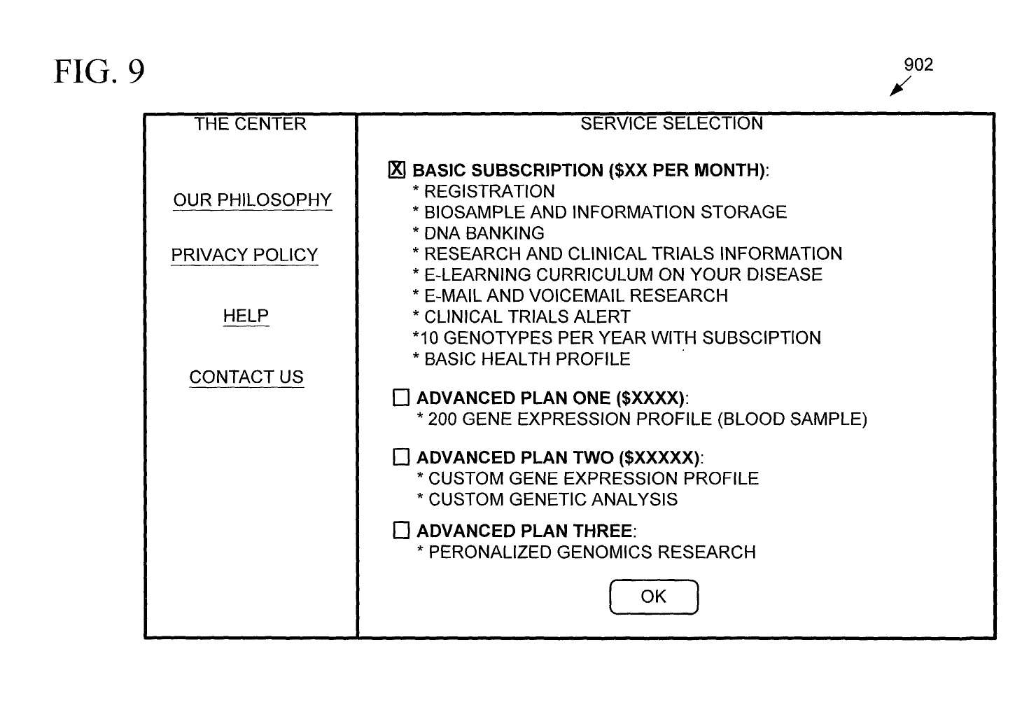

Service options are shown in the screenshot 902 of FIG. 9. Typically, a user begins with the basic subscription level. In some cases, a user may not wish to join any services, in which case the registration serves as a pre-registration process, after which the genomic information center might contact the user to determine what level of service is appropriate.

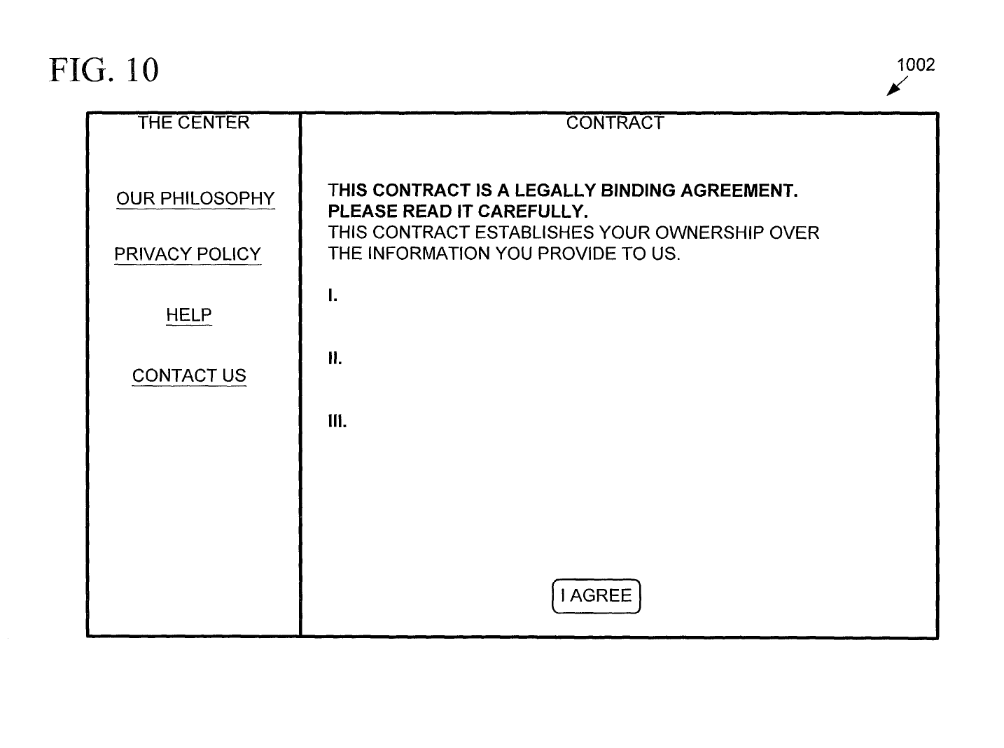

The screenshot 1002 of FIG. 10 shows a contract presented to a user to complete the registration process. A printable version of the contract can be presented, and the user can print the printable version for her records. The genomic information center can serve as a clearinghouse for personal genomic profile information and establish a trust relationship with participants.

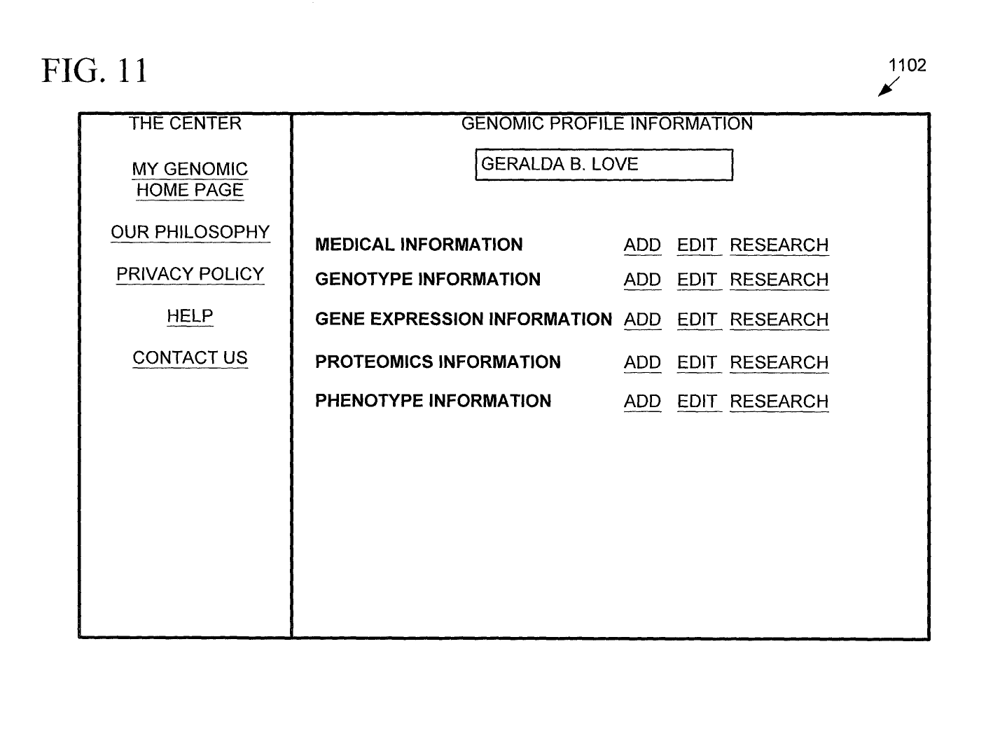

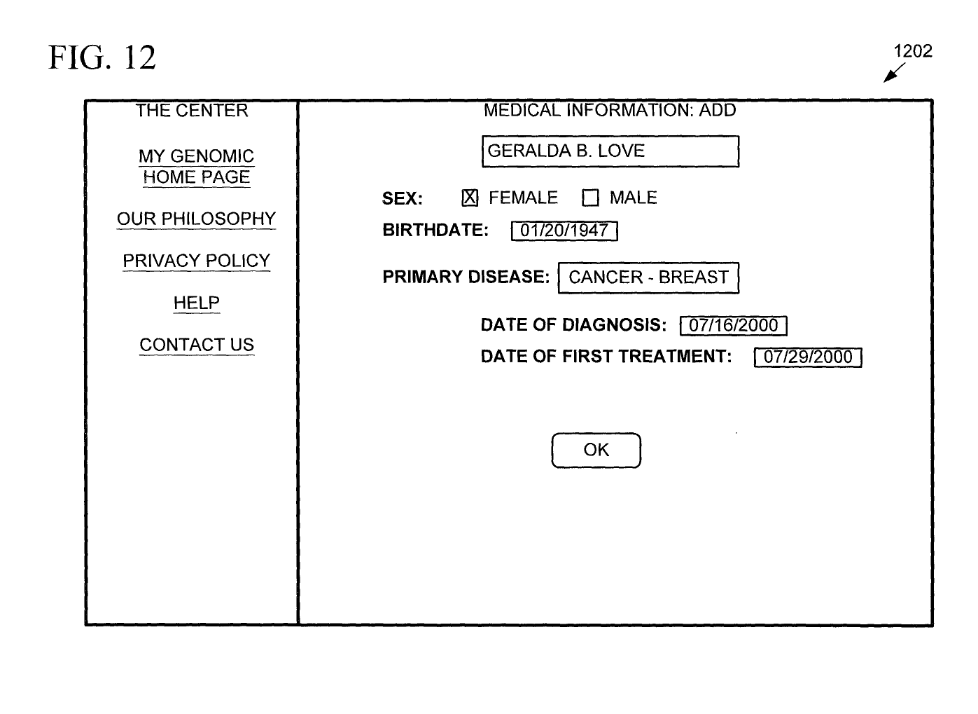

The screenshot 1102 of FIG. 11 shows options presented to a user for adding, editing, or researching various aspects of her personal genomic profile information. For example, when a participant chooses to add medical information, the form shown in screenshot 1202 of FIG. 12 is presented. The participant can then add medical information as appropriate.

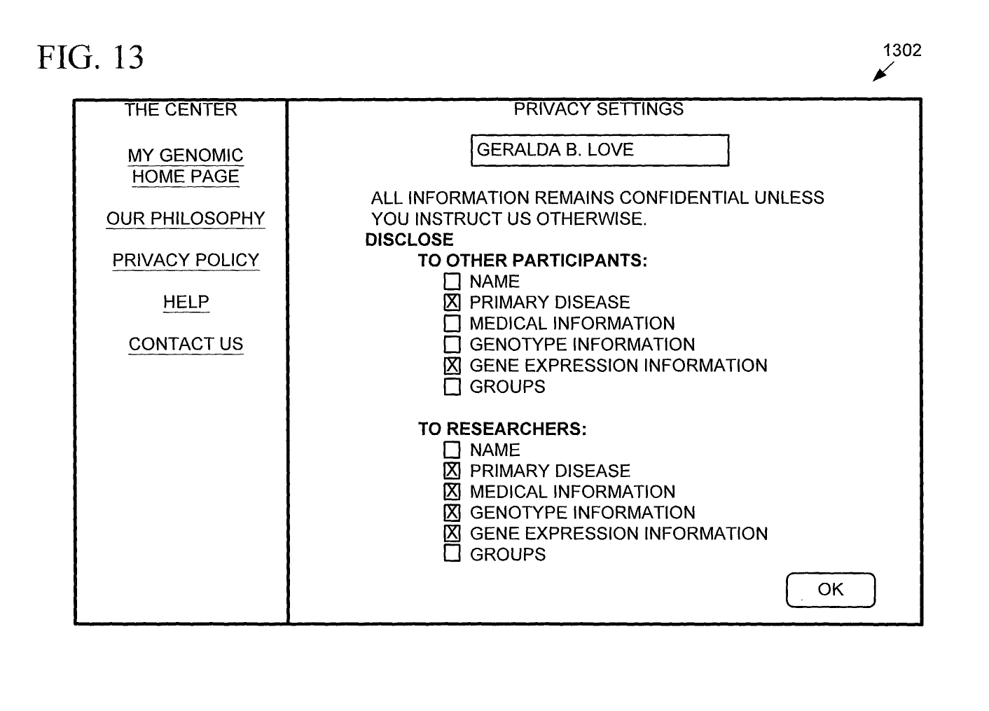

The user can also perform custodial functions on her data. For example, access to a participant's information is controlled by the participant as shown by the screenshot 1302 of FIG. 13. Similarly, control can also be exercised over whether members of a particular group (e.g., colon cancer patients) have access to various data.

Additional configuration screens may be presented by which a participant can customize the information presented by the genomic information center. Typically, after having completed registration, a participant is provided with her username and password. The participant thus can control privacy settings for herself and configure the privacy settings over a communications network, such as the Internet.

### Operation: Second Example

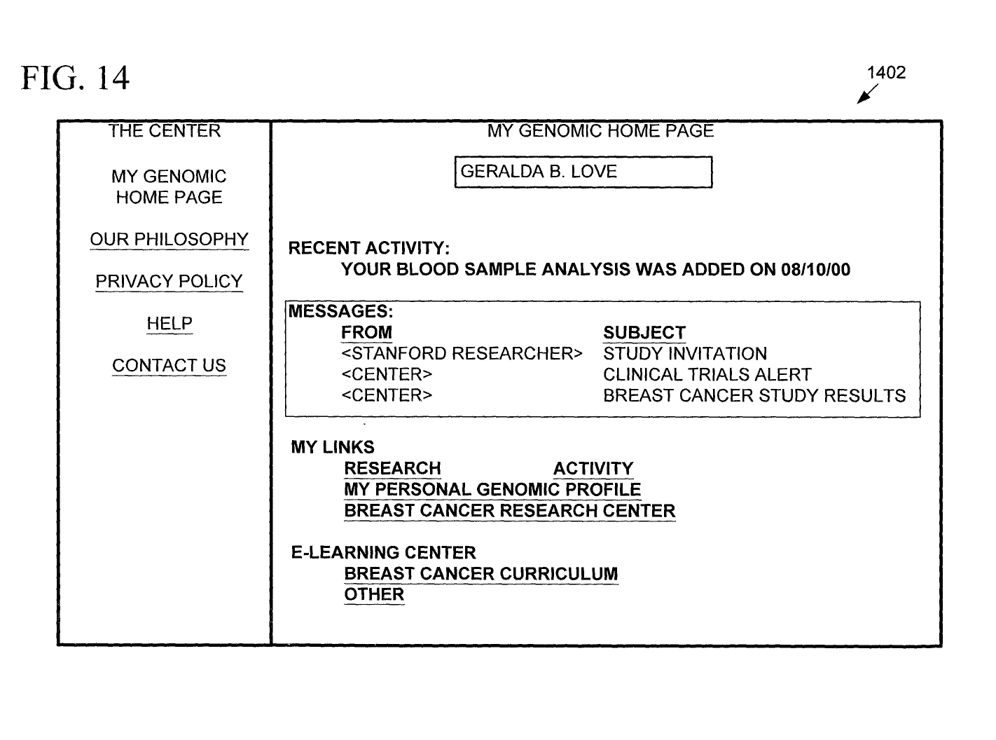

Typically, after a participant registers, she returns to the center to monitor information and perform other functions. After logging in to the center, a personal genomic home page is presented as shown in the screenshot 1402 of FIG. 14. The home page shows recent activity, messages, customized links, and links to an e-learning center. Notifications related to the participant's medical condition are provided, as are links relating to her medical condition.

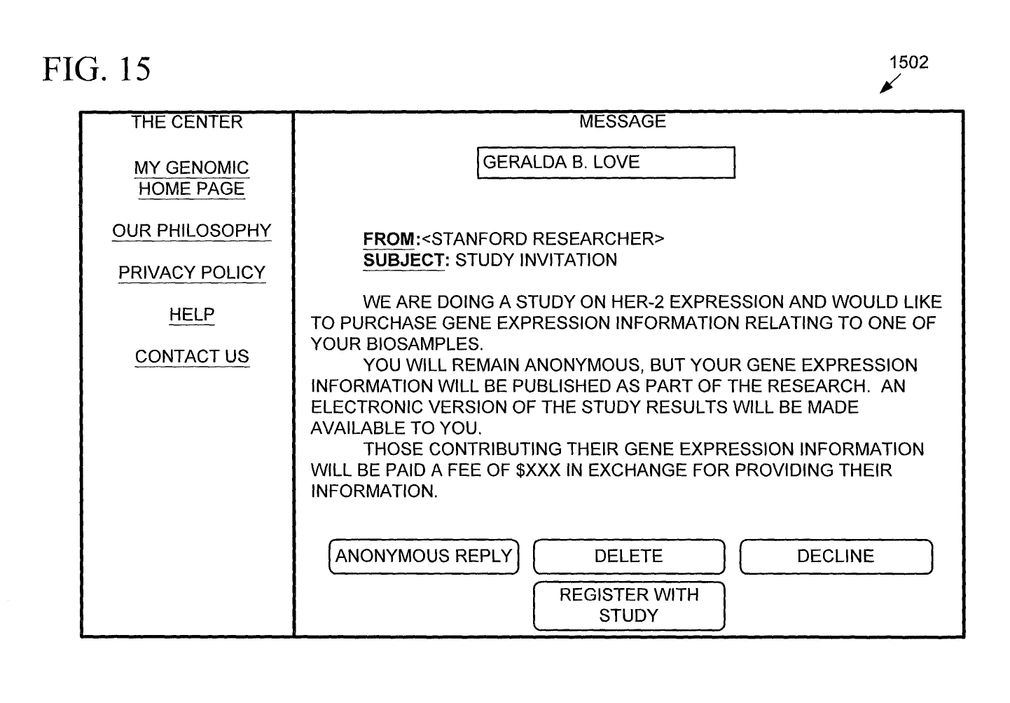

To read a message, the message is selected (e.g., via double clicking). For example, the screenshot 1502 of FIG. 15 shows a message presented to a participant and inviting the participant to register with a research study.

Other messages may be presented. For example, a participant may communicate anonymously with another participant to inquire about treatment and medical professionals.

### Operation: Third Example

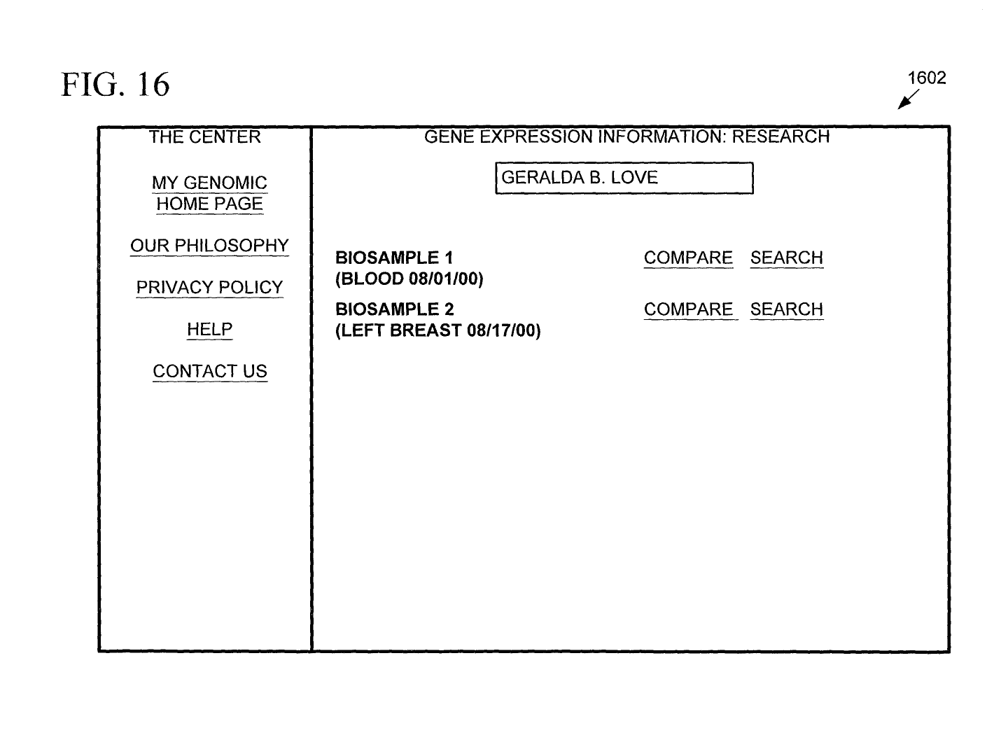

The genomic information center also presents an opportunity for participants to conduct their own research, including comparative genomic profile analysis. For example, the screenshot 1602 of FIG. 16 shows research options presented for two biosamples provided by a participant. Search functions allow the participant to find information relating to and explaining the results of analysis performed on the search. Typically, analysis is provided by a laboratory.

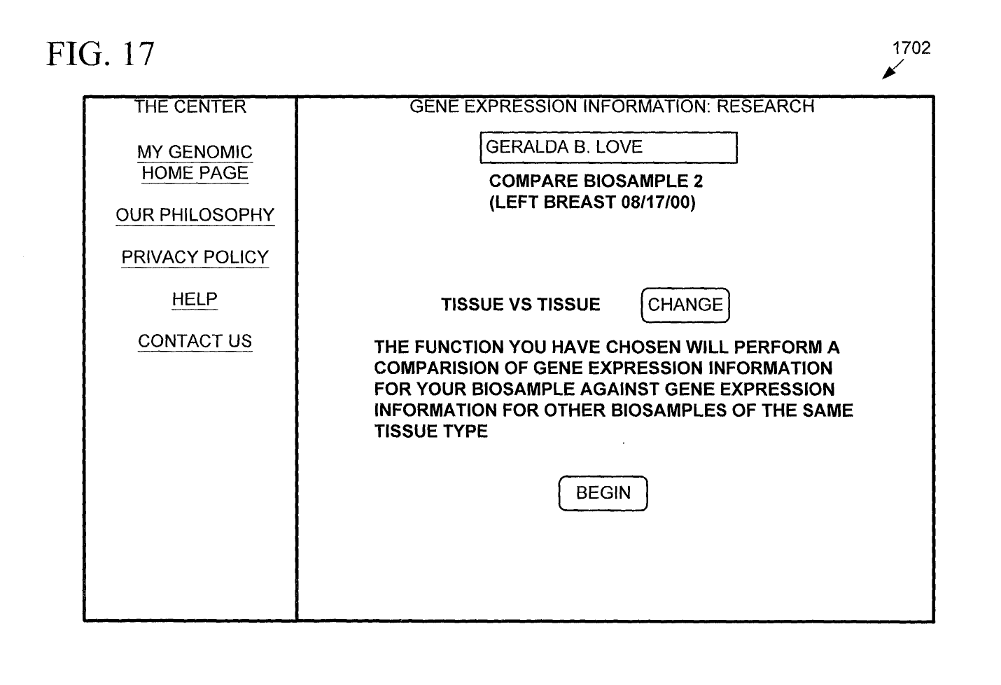

As a result of selecting the compare option for biosample 2, the participant is presented with options for performing analysis on information relating to the biosample. For example, the screenshot 1702 of FIG. 17 shows a screen by which a participant can initiate a comparative gene expression analysis for a biosample. Gene expression for the biosample is compared to other biosamples of the same tissue type.

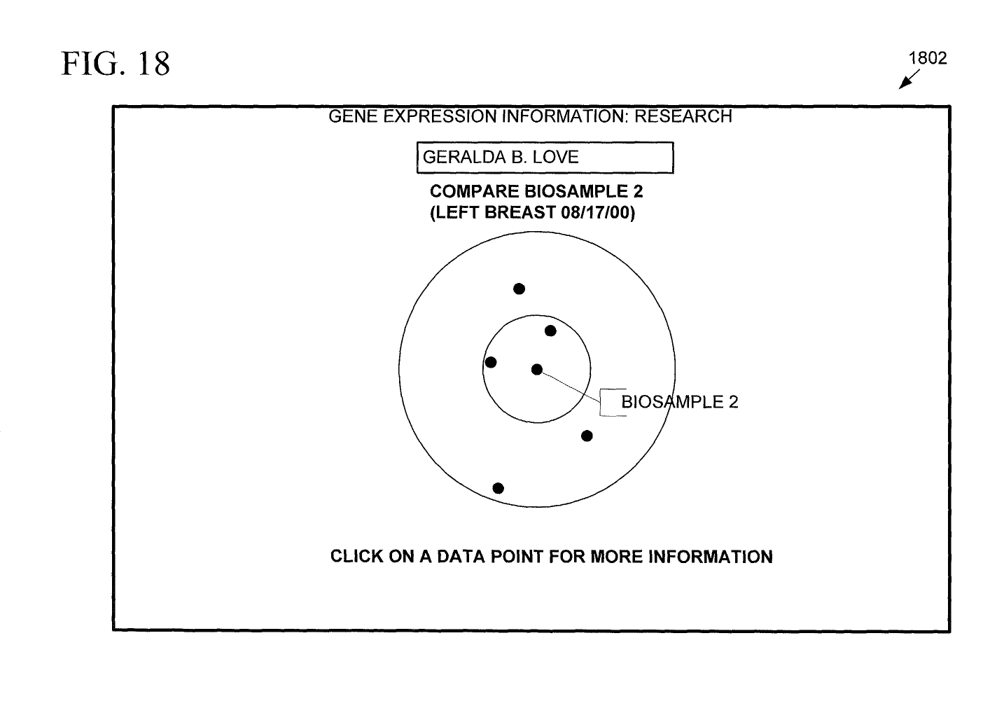

As a result of initiating the comparative analysis, gene expression information (e.g., gene expression levels vis-a-vis a control tissue) is compared for a variety of genes. Other participants' biosamples having characteristics closest to the participant's biosample are presented as being in a cluster. Levels of statistical significance are presented. For example, as shown in the screenshot 1802 of FIG. 18, rings around a point indicate a cluster of 2 biosamples closely similar to the participant's biosample and 3 others that are relatively less similar to the participant's biosample. The points represent biosamples.

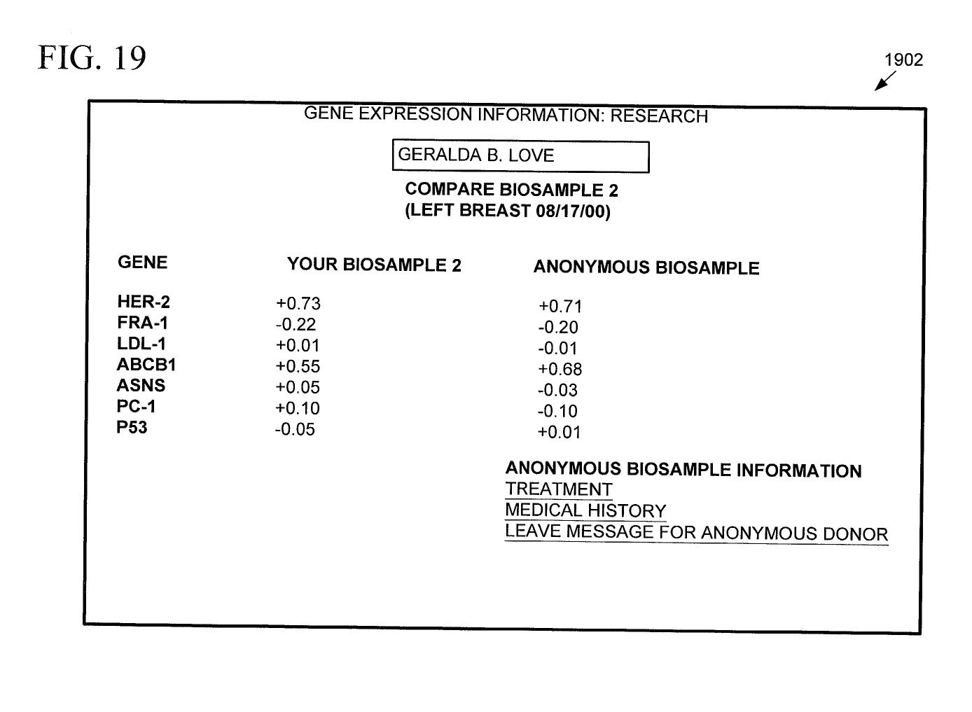

The participant can select one of the biosamples by clicking on a point, and information about the biosample is presented. For example, as shown in the screenshot 1902 of FIG. 19, the biosample is presented side by side with the biosample selected. The participant can further investigate the treatment and medical history of the person associated with the biosample. Some information may not be available due to privacy options. In some embodiments, the anonymous biosample may be identified with an identifier associated with the anonymous participant but not revealing the anonymous participant's name.

Similar operations can be performed for other areas of the personal genomic profile. For example, genotype information can be compared to find other individuals having similar genotypes.

### Operation: Fourth Example

The center can suggest a group (e.g., a group for diabetes or breast cancer) that the participant may wish to join. The participant can join the group, access group information, and perform group functions. The group members can exchange information on line, and a group moderator (who may or may not be a group member) maintains a list of information for group members, including hyperlinks to studies and other information. A participant is presented with a list of links to information about their condition.

### Operation: Fifth Example

Information regarding a study can be provided to a participant. In exchange for registering for the study and providing information, payment is provided to the participant. The payment can be supplied from a research entity.

### Operation: Sixth Example

A lab can upload information relating to an analysis of a biological sample, and the information is incorporated into the database system. Gene expression information can be acquired in a variety of ways, including cDNA microarray technology. The information can be uploaded via a communications network connection such as the Internet. Gene expression information can be transmitted and stored in a database in a variety of formats, including XML formats or other markup languages. For example, Rosetta Inpharmatics of Kirkland, Washington has specified GEML (Gene Expression Markup Language), a file format for storing DNA microarray and gene expression data, but other formats can be used. Proteomics information can also be transmitted and stored in similar formats, including XML-based formats.

### Operation: Seventh Example

A researcher can request a collection of information comprising genomic profile information data. For example, if the database has 10,000 cancer patients, there may be 1,000 patients in the database with a rarer form of cancer (e.g., renal cancer) that is not well described in the medical literature.

The researcher can specify criteria over a communications network connection and be provided with a number indicating how many patients in the database. Based on the number provided, the researcher can then work with the center to assemble an appropriate arrangement by which the individuals meeting the criteria can be invited to register to provide their genomic profile information (e.g., including gene expression information relating to tumors) in compensation for payment.

The researcher might analyze the data to find, for example, which genes have been turned on in renal cancer patents and then work on developing a drug to block activation of the genes.

A similar method can be used by a researcher to recruit persons for clinical trials. The results of the clinical trials can then be posted to the center for consideration by participants. An advantage to such an arrangement is that the participants are effectively pre-screened because they have already provided some information about themselves to the center. For example, there may be 25,000 diabetic patients in the center database. Researchers wishing to conduct clinical trials to research a cure for diabetes are thus presented with an easily-accessible list of clinical trial candidates. Participants can control the amount of information available to researchers.

### Operation: Eighth Example

An administrator at the center can receive a researcher's request for a collection of information and approve the request for distribution to appropriate participants. The participants can accept or reject the request.

### Operation: Ninth Example

Software for manipulating and analyzing data produced by microarray platforms can include LIFEARRAY software from Incyte Genomics of Palo Alto, Calif. The center can incorporate technologies of such software or similar alternatives.

The system for storing genomic profile information typically includes a relational database, and individuals are assigned a unique identifier. Results of analyses of biosamples can also be stored in the database. For example, a standard for databases related to gene expression has been developed by the Genetic Analysis Technology Consortium (GATC). Documents entitled “Software Specifications” and “GATC Expression Database” were published in 1998 by the consortium, which includes Affymetrix Incorporated of Santa Clara, Calif. and Molecular Dynamics of Sunnyvale, Calif.; these two documents are hereby incorporated herein by reference. A genomic profile information can implement such standards to facilitate storage, analysis, and exchange of information between participants and researchers, or other techniques can be used.

### Implementation: Tenth Example

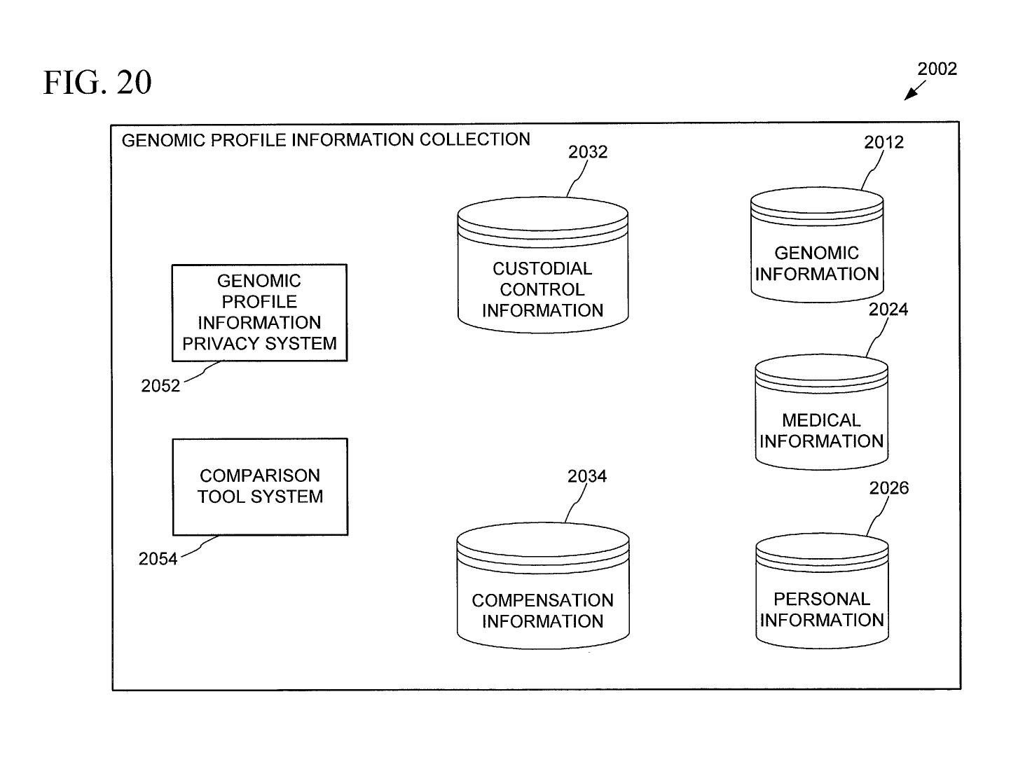

FIG. 20 shows a block diagram of an exemplary implementation of a genomic profile information collection system 2002, which can be used to implement the above examples and can operate via connection to a communications network, such as the Internet. In the example, records for a participant's genomic profile can be spread among a genomic information database 2012 (e.g., for storing any of the genomic information indicated above), a medical information database 2024 (e.g., for storing any of the medical information indicated above), and a personal information database 2026 (e.g., for storing personal information as indicated above).

The information collection can also include a custodial control information database 2032 (e.g., such as that manipulated by a participant in FIG. 13, above) and a compensation information database 2034. The custodial control information database 2032 can include privacy settings for at least one of the participants.

The compensation information database 2034 can include information about compensation to be provided (or already provided) to participants. For example, a system can indicate which services (e.g., analysis of a biosample for gene expression measurement or comparisons to other participants) are available to the participant as compensation for registering with the system or granting access to the participant's genomic profile information. Compensation information can also indicate goods or services for a participant (e.g., payment due based on having provided information for a research study).

A genomic profile information privacy system 2052 can include software that controls access to genomic profile information and maintains confidentiality and anonymity within the system 2002. For example, requests for information can be denied if not authorized, and group memberships can be maintained. The software system enforces confidentiality of genomic profile information for a participant unless otherwise specified by the participant (e.g., as shown in FIG. 13, above). The privacy system 2052 can control network access to genomic profile information for a participant based on privacy settings (e.g., those in the custodial control information database 2032). A participant can control the privacy settings for herself, and the privacy settings can be configured by the participant over a communications network such as the Internet.

A comparison tool system 2054 can include software that performs comparisons of information for participants, allowing participants to engage in self-directed research (e.g., as shown in FIG. 17, above). The comparison tool system can work in conjunction with the privacy system 2052 to maintain confidentiality and anonymity as controlled by the participants.

Comparison can be done in various ways. For example, a participant can access and view another participant's information if authorized. Or, a participant can direct software to access another participant's on behalf of the comparing participant. Privacy settings can be configured to address such scenarios (e.g., whether a participant's genomic profile can be examined by other participants, examined on behalf of another participant, or examined at the request of another participant).

In a system in which at least some genomic profile information is stored at a computer system under control of a participant (e.g., a peer-to-peer arrangement or distributed database arrangement), various portions of the collection may reside at other computer systems. For example, a reference to a computer at which the information can be accessed via a communications network can be stored in place of the actual information. The software accordingly directs requests for information residing on the computer system under the participant's control to the computer system under the participant's control. The computer system under control of the participant may reside at the participant's home or other remote location and can include software for responding to information requests.

Other database arrangements than those shown are possible. For example, information can be stored in a variety of tables in a single database, or any number of databases can be used to provide similar functionality.

The system 2002 can include technologies for presenting various user interfaces and exchanging information over a communications network, such as the Internet. The system 2002 can be used alone, in conjunction with, or in various combinations with that shown in FIG. 1.

### Further Information

The following are incorporated herein by reference: PCT Document WO 96/23078, entitled “Computer System Storing and Analyzing Microbiological Data” and Sabatini et al., U.S. Pat. No. 5,966,712, filed May 15, 1997, entitled “Database and System for Storing, Comparing and Displaying Genomic Information.”

### Alternatives

Although the term “participant” is used above to describe a single person or patient, a participant can also include two people, such as when a parent or guardian registers a minor child. In such a case, the personal genomic profile relates to the minor child, but other aspects of the technology might pertain to the minor child or the parent or guardian.

Although some of the above examples illustrate an implementation using the Internet, the technologies can be carried out in other ways using other networks.

In view of the many possible embodiments to which the principles of the invention may be applied, it should be recognized that the illustrated embodiments are examples of the invention, and should not be taken as a limitation on the scope of the invention. Rather, the scope of the invention includes what is covered by the following claims. I therefore claim as my invention all that comes within the scope and spirit of these claims.

I claim:

1. A genomic profile information system accessible over a communications network, the genomic profile information system comprising:
data for a plurality of participants indicating genomic profile information of the participants; and
a software system comprising privacy settings for at least one of the participants and controlling access by others over the communications network to genomic profile information of the participant, wherein the participant controls the privacy settings for the participant, and the privacy settings for the participant can be configured by the participant over the communications network.

2. The genomic profile information system of claim 1 wherein the software system enforces confidentiality for the genomic profile information of the participant unless otherwise specified by the participant.

3. The genomic profile information system of claim 1 wherein:
the settings indicate a computer system under a participant's control on which at least some of the participant's genomic profile information resides; and
the software system accordingly directs requests for information residing on the computer system under the participant's control to the computer system under the participant's control.

4. The genomic profile information system of claim 3 wherein at least some of the participant's genomic profile information residing on a computer system under the participant's control is provided to another participant via a peer-to-peer network arrangement.

5. The genomic profile information system of claim 1 wherein identity of the participant is authenticated over the communications network via biometric screening.

6. The genomic profile information system of claim 1 wherein the privacy settings comprise separate privacy settings for other participants and for researchers.

7. The genomic profile information system of claim 1 wherein the privacy settings comprise separate privacy settings indicating whether medical information of the participant can be accessed by others.

8. The genomic profile information system of claim 1 wherein:
the software system indicates whether the participant is a member of one or more groups; and
the privacy settings comprise separate privacy settings indicating whether group membership information of the participant in the system can be accessed by others.

9. The genomic profile information system of claim 1 wherein the privacy settings comprise separate privacy settings indicating whether a primary disease of the participant can be accessed by others.

10. The genomic profile information system of claim 1 wherein:
the settings indicate whether a participant's genomic profile information can be examined by other participants; and
the software system accordingly allows examination of the participant's genomic profile information by other participants while preserving anonymity of the participant.

11. The genomic profile information system of claim 10 wherein:
the settings indicate one or more participants are members of a group;
the settings indicate whether a participant's genomic profile information can be examined by other participants who are members of the group; and
the software system accordingly allows examination of the participant's genomic profile information by other participants who are members of the group while preserving anonymity of the participant.

12. The genomic profile information system of claim 1 further comprising:
software for identifying two or more participants having similar genomic profile information; wherein the identifying software presents a user interface option to a participant for contacting another similar participant while maintaining anonymity of the similar participant.

13. The genomic profile information system of claim 1 wherein:
the settings comprise an identifier by which a participant can be identified anonymously; and
the software system accordingly identifies the participant via the identifier.

14. The genomic profile information system of claim 1 wherein the settings indicate whether a participant's genomic profile information can be examined by other participants.

15. The genomic profile information system of claim 1 wherein the settings indicate whether a participant's genomic profile information can be examined on behalf of other participants.

16. The genomic profile information system of claim 1 wherein the settings indicate whether a participant's genomic profile information can be examined for a comparison at the request of another participant.

17. The genomic profile information system of claim 1 wherein the settings indicate whether a participant's genomic profile information can be distributed.

18. The genomic profile information system of claim 1 wherein the settings indicate an organization to which a participant's genomic profile information can be distributed.

19. The genomic profile information system of claim 1 wherein a set of participants have a disease condition, and the genomic profile information comprises information indicating the outcomes of such therapies.

20. The genomic profile information system of claim 1 wherein the genomic profile information system further comprises comparison tools operable by a researching participant having a disease condition, and the tools identify therapy outcomes for participants having a disease condition and molecular portrait similar to the researching participant.

21. The genomic profile information system of claim 1 further comprising:
a comparison tool software system comprising comparison tools for comparing genomic profile information for two or more participants.

22. The genomic profile information system of claim 21 wherein the participant is a patient having a disease condition, and the comparison tools support patient-driven comparative analyses of genomic profile information over a communications network.

23. The genomic profile information system of claim 21 wherein at least one of the tools compares gene expression.

24. The genomic profile information system of claim 21 wherein at least one of the tools compares drug response information.

25. The genomic profile information system of claim 21 wherein the comparison tools provide comparison results indicating one or more participants, and the participants are listed anonymously in the comparison results.

26. The genomic profile information system of claim 25 wherein at least one of the anonymous listings of the participants can be selected by a computer user interface to send a message to the anonymously-listed participant.

27. The genomic profile information system of claim 1 wherein the genomic profile information comprises genomic pathology information for one or more participants.

28. The system of claim 1 wherein the system has information for over 10,000 participants.

29. The system of claim 1 wherein the system has information for over 100,000 participants.

30. The system of claim 1 wherein the system has information for over 1,000,000 participants.

31. The system of claim 1 wherein the system has information for over 10,000,000 participants.

32. The system of claim 1 wherein the system has information for over 100,000,000 participants.

33. A method comprising:
registering an individual as a participant in a genomic profile information center;
collecting personal genomic profile data of the participant;
adding the participant to a genomic profile information database; and
granting the participant custodial control over the participant's genomic profile information.

34. A computer-readable medium comprising computer-executable instructions for performing the method of claim 33.

35. The method of claim 33 wherein custodial control comprises controlling, via a computer user interface, whether the participant's genomic profile information is to be provided to others.

36. The method of claim 33 wherein custodial control comprises controlling, via a computer user interface, whether the participant's genomic profile information is to be provided for use in a particular study.

37. The method of claim 33 wherein custodial control comprises controlling whether other participants being members of a designated group can access the participant's genomic profile information.

38. The method of claim 37 wherein the participant's genomic profile information is identified anonymously.

39. The method of claim 33 further comprising:
as a result of receiving authorization from the participant to provide the participant's genomic profile information for use in research, compensating the participant.

40. The method of claim 39 wherein compensation originates from payment by a third party.

41. A method comprising:
analyzing a biological sample collected from a patient to generate a genomic profile for the patient;
incorporating the genomic profile for the patient into a genomic profile information collection comprising genomic profile information for a plurality of other patients; and
compensating the patient by providing at least some level of access to the genomic profile information collection.

42. The method of claim 41 wherein the genomic profile information collection comprises a network of computers communicating via a peer-to-peer network arrangement.

43. The method of claim 41 wherein incorporating comprises storing a reference to a computer under control of the patient at which genomic profile information for the patient can be accessed.

44. The method of claim 41 wherein the genomic profile for the patient is stored on a computer system under control of the patient and accessed by others by accessing the computer system under control of the patient.

45. The method of claim 41 wherein the genomic profile for the patient is stored on a computer system under control of the patient and access to the genomic profile for the individual is provided by the computer system under control of the patient.

46. A method comprising:
registering an individual as a participant in a genomic profile information network;
collecting genomic profile information from the participant, wherein the genomic profile information from the participant comprises gene expression information for one or more genes based on a biological sample taken from the participant;
adding the genomic profile information from the participant to a collection of data comprising genomic profile information from other participants, wherein the genomic profile information from the other participants comprises gene expression information for the one or more genes based on biological samples taken from the other participants;
comparing the genomic profile information of the participant with that from the other participants to generate comparison results indicating closeness between the participant's genomic profile information and genomic profile information of one or more of the other participants; and
presenting the genomic profile information of the one or more other participants, wherein identities of the one or more other participants remain anonymous.

47. The method of claim 46 further comprising:
accepting a selection via a graphical user interface from the participant indicating a message is to be sent to the one or more other participants; and
responsive to the selection, sending a message to the one or more other participants.

48. A genomic profile information center granting patients control over their personal genomic profiles.

49. A method of operating a genomic profile information center, wherein patients are granted control over their personal genomic profiles.

50. The method of claim 49 comprising:
collecting personal genomic profile information from thousands of remote participants.

51. A method of providing a genomic profile information database, wherein participants exercise control over their genomic profile information.

52. A method comprising:
compensating a person in exchange for contributing information to a genomic profile information database.

53. The method of claim 52 wherein proceeds for compensating the person come from sale of the information to an entity requesting the information from an information center.

54. The method of claim 52 wherein the information is contributed by providing a personal biological specimen from the person.

55. A method comprising:
collecting a biological sample from a person;
performing analysis on the sample to generate personal genomic profile for the person;
pooling the personal genomic profile with personal genomic profiles from other people into a collection of anonymous personal genomic profiles;
selling the collection of anonymous pooled personal genomic profiles to a requesting entity for payment; and
as a result of the sale, compensating the person via the payment.

56. A method comprising:
directing a person to supply a biological sample from the person's body to a laboratory;
receiving an analysis of the biological sample from the laboratory and incorporating the analysis into a personal genomic profile for the person;
pooling the personal genomic profile with personal genomic profiles from other people into a collection of anonymous personal genomic profiles;
selling the collection of anonymous pooled personal genomic profiles to a requesting entity for payment; and
as a result of the sale, compensating the person via the payment.

57. A method for motivating a person to contribute information to a genomic profile information database, the method comprising:
compensating the person in exchange for contributing information to the genomic profile information database.

58. A method for motivating a participant to contribute to a genomic profile information database, the method comprising:
at the direction of the participant, receiving personal genomic profile information of the participant for addition to the database; and
providing monetary compensation to the participant in exchange for receiving the personal genomic profile information of the participant.

59. A method for motivating a participant to contribute to a genomic profile information database, the method comprising:
receiving personal genomic profile information of the participant for addition to the database;
adding the personal genomic profile information to the database; and
providing comparative genomic analysis to the participant in exchange for receiving the personal genomic profile information of the participant, wherein the comparative genomic analysis comprises comparing the personal genomic profile information to personal genomic profile information for other participants in the database.

60. The method of claim 59 wherein receiving personal genomic profile information of the participant comprises:
receiving genotype information of the participant; and
receiving phenotype information of the participant.

61. The method of claim 58, further comprising:
receiving payment for a collection of genomic profile information comprising the individual genomic profile information;
wherein the monetary compensation is derived from the payment.

62. The method of claim 58, further comprising:
combining the individual genomic profile information into a collection of genomic profile information comprising the individual genomic profile information; and
selling the collection of genomic profile information comprising the individual genomic profile information in exchange for a payment;
wherein the monetary compensation is derived from the payment.

63. A method comprising:
storing a personal genomic profile for a participant in a database;
designating the participant as a member of a group; and
providing the participant with access to group functions and information.

64. The method of claim 63 wherein the group functions include exchanging information with other group members.

65. The method of claim 63 further comprising:
limiting members of the group to those interested in acquiring information about a particular medical condition.

66. The method of claim 63 further comprising:
limiting members of the group to those having a particular medical condition.

67. The method of claim 63 further comprising:
limiting members of the group to those having substantially similar age, sex, or race.

68. A method for presenting analysis of a set of personal genomic profiles, the method comprising:
designating a set of personal genomic profiles;
identifying differences and similarities in the set of personal genomic profiles; and
displaying the differences and similarities in the set of personal genomic profiles.

69. The method of claim 68 wherein the displaying generates a web page for viewing by participant who has provided information for a personal genomic profile in the set.

70. A method for building a genomic profile information database, the method comprising:
responsive to the request of an individual human being, adding a personal genomic profile for the individual human being to the database;
receiving a request to provide a collection of information comprising the personal genomic profile to a requester in exchange for payment;
responsive to the request to provide a collection of information comprising the personal genomic profile, providing an anonymous version of the personal genomic profile from the database to the requester in exchange for payment; and
based on having provided the anonymous personal genomic profile to the requestor, compensating the individual human being for having added the personal genomic profile via the payment.

71. A method for providing a service to a remote customer, the method comprising:
obtaining a personal genomic profile of the customer;
pooling the profile with other profiles;
selling the pool; and
passing compensation back to the customer.

72. A method for providing a service to a remote customer, the method comprising:
obtaining a personal genomic profile of the customer;
pooling the profile with other profiles;
over a computer network connection, providing the customer with tools to compare the profile with other profiles in the pool.

73. A method of providing a personal genomic information service to a participant, the method comprising:
obtaining information and a biological sample from the participant to generate a personal genomic profile; and
granting the participant the ability to perform custodial functions on the profile.

74. The method of claim 73 wherein the custodial functions comprise:
selling the personal genomic profile.

75. The method of claim 73 wherein the custodial functions comprise:
comparing the personal genomic profile with personal genomic profiles of other participants.

76. The method of claim 73 wherein the custodial functions comprise:
sharing an anonymous version of the personal genomic profile with other participants.

77. A method comprising:
signing a contract over the Internet establishing ownership of personal genomic profile information.

78. A method comprising:
accepting a contract signature over the Internet establishing ownership of personal genomic profile information.

79. A method of acquiring personal genomic profile information for use in a research study, the method comprising:
offering payment for a collection of anonymous genomic profiles

80. A method of selling personal genomic profile information, the method comprising:
offering an anonymous version of one's personal genomic profile in exchange for payment.

81. A method of selling personal genomic profile information, the method comprising:
providing an anonymous version of one's personal genomic profile to be pooled with the personal genomic profile of others;
authorizing via a computer user interface over a communications network a sale of the pooled personal genomic profile in exchange for payment; and
accepting a portion of the payment.

82. A method of selling personal genomic profile information, the method comprising:
in exchange for payment, contributing an anonymous version of one's personal genomic profile to a pool to be sold in exchange for payment.

83. A method of providing a genomic profile information clearinghouse, the method comprising:
establishing a trust relationship with an individual;
at the direction of the individual, accepting personal genomic profile information about the individual;
conducting a sale of the personal genomic profile information about the individual to a third party; and
paying the individual from proceeds of the sale.

84. A method of providing a genomic profile information clearinghouse, the method comprising:
receiving personal genomic profile information from an individual;
providing the genomic profile information to a third party in exchange for payment; and
providing a portion of the payment to the individual.

85. A method of providing a genomic profile information clearinghouse, the method comprising:
receiving personal genomic profile information from an individual;
combining the personal genomic profile information into a pool of genomic profile information;
providing the pool to a third party in exchange for payment; and
providing a portion of the payment to the individual.

86. A method of presenting information from a genomic profile information database having a plurality of entries for a plurality of persons, wherein the entries indicate traits of the persons, the method comprising:
finding persons having common traits in the database;
displaying a graphical representation of the persons having common traits, wherein identities of the plurality of persons remains anonymous.

87. A computer-readable medium having computer-executable instructions for performing the following:
receiving personal genomic profile information for an individual;
adding the personal genomic profile information to a database;
retrieving a pool of information from the database;
receiving an indication that the pool of information has been sold; and
responsive to receiving the indication, recording compensation data indicating the individual is to be compensated.

88. The computer-readable medium of claim 87 wherein receiving the profile information comprises receiving the profile information over a computer network connection.

89. The computer-readable medium of claim 88 wherein receiving the profile information comprises receiving the profile information from a remote laboratory.

90. The computer-readable medium of claim 87 wherein the indication is received over a computer network connection.

91. The computer-readable medium of claim 87 wherein the pool of information from the database is a set of personal genomic profiles having specified criteria.

92. The computer-readable medium of claim 91 further comprising computer-readable instructions for performing the following:
receiving the specified criteria from a researcher; and
presenting a number of individuals meeting the criteria to the researcher.

93. A genomic profile information center comprising:
a collection of personal genomic profiles for a plurality of participants; and
tools for comparing the personal genomic profiles with a genomic profile of a particular participant.

94. A genomic profile information center comprising:
means for collecting personal genomic profiles from a plurality of participants;
means for pooling the personal genomic profiles into a collection of personal genomic profiles; and
means for recording compensation due to a participant as a result of having sold the collection to a requesting entity.
